(19) United States
(12) Patent Application Publication
(10) Pub. No.: US 2020/0290898 A1
(43) Pub. Date: Sep. 17, 2020

(54) METHOD AND APPARATUS FOR WATER TREATMENT AND A CLEANING FLUID

(71) Applicant: Nazmi FETAJ, Reutlingen (DE)

(72) Inventor: Nazmi FETAJ, Reutlingen (DE)

(21) Appl. No.: 16/815,623

(22) Filed: Mar. 11, 2020

(30) Foreign Application Priority Data
Mar. 12, 2019 (DE) 102019106305.1

(51) Int. Cl. C02F 1/461

(52) U.S. Cl. CPC C02F 1/4618; C02F 1/46109; C02F 2103/02; C02F 2001/46195; C02F 2001/46171

(57) ABSTRACT

A method, in particular for producing a cleaning fluid, comprising conveying an aqueous solution through a treatment device, in particular an electrochemical treatment device, which comprises an electrode pair through which the aqueous solution flows, in particular for the activation thereof.

In order to provide a simplified water treatment method, in particular for producing a cleaning fluid, the region between the electrodes of the electrode pair is configured such that it is open to intermixing, and in particular is free from a membrane or diaphragm.

According to a first aspect, the present invention relates to a water treatment method, in particular for producing a cleaning fluid.

A method known as “electrochemical activation”, in which an aqueous salt solution is used to produce cleaning fluids, has been known for some time from the prior art.

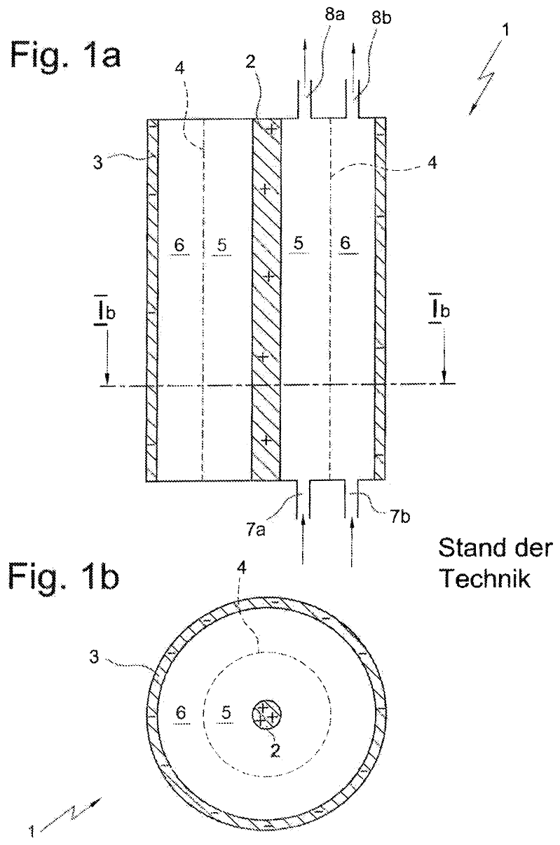

FIG. 1a shows an example of such a prior art method having a prior art electrochemical treatment device 1. This device 1 has a rod-shaped central anode 2 and a cathode 3 arranged coaxially in the manner of a cylindrical sheath. Likewise coaxially, a membrane 4 (or a diaphragm 4) is arranged therebetween, which essentially divides the device into two chambers: an inner anode chamber 5 and an outer cathode chamber 6. A separate feed 7 and a separate discharge 8 are assigned to each of these two chambers 5 and 6, as shown in FIG. 1a. If an aqueous salt solution, typically having a salt content of more than 0.5 percent, is fed in through the feeds 7, and if a direct current is applied between the anode 2 and the cathode 3, the introduced fluid can be chemically activated in the device 1.

The membrane 4 here acts such that it prevents the fluids or solutions present in the chambers 5 and 6 from intermixing. These solutions therefore cannot intermix. On the other hand, the membrane allows for a diffusion of ions of the solutions in the chambers 5 and 6, which ions being directed to the anode 2 or cathode 3 according to their polarity. This results in the formation of an acidic anode fluid in the anode chamber 5 and an alkaline cathode fluid in the cathode chamber 6.

After a certain treatment time, these two fluids can leave the device 1 by way of the discharges 8, after which they form two cleaning fluids with completely different properties. For example, one of the cleaning fluids can have a pH value of 2 to 3.5 and the other a pH value of 10 to 13. To obtain a suitable cleaning fluid, it is further known to mix these two separate fluids in a predefined ratio to obtain a desired cleaning fluid with a pH value of between 8 and 9.

The described prior art method has proved to be in need of improvement in so far as the construction with a delicate membrane is considered to be relatively complicated, and in particular the preparation of a cleaning fluid by mixing two different starting fluids represents a laborious work step.

It is therefore the object of the present invention to provide a simplified water treatment method, in particular for producing a cleaning fluid.

The invention achieves this goal according to a first aspect with the features of claim 1, in particular with those of the characterizing portion, and is accordingly characterized in that the region between the electrodes of the electrode pair is configured such that it is open to intermixing, and in particular is free from a membrane or diaphragm.

In other words, the idea behind the invention consists in omitting the membrane or diaphragm and thus providing only a single chamber between the two electrodes.

A particular consequence of this is that only one inlet and a single outlet are required, which significantly simplifies the construction of the treatment device and the implementation of the method according to the invention. In particular, when a corresponding method is carried out, only one fluid is obtained which can be used directly as a cleaning fluid (with no need for any laborious mixing processes of multiple starting fluids or an appropriate dosing apparatus).

While the region between the electrodes is not configured such that it is open to intermixing in the device according to the prior art, since a membrane or diaphragm is generally arranged there (which prevents the fluids in the two chambers from intermixing), an according intermixing-barrier is just not provided according to the present invention. An intermixing-barrier is therefore not present in comparison to the prior art.

Even if, according to the prior art, the intermixing-barriers (membrane or diaphragm) permit the migration of ions (at least in part), respectively representing no great resistance, in the prior art they do divide the region between the electrodes into two separate chambers in terms of intermixing.

According to the invention on the other hand, it is provided that substantially a common chamber (open to intermixing) is provided between the electrode pairs. The electrodes thus form precisely one chamber (with preferably precisely one feed and precisely one discharge) between them or are jointly arranged in such a chamber.

“Open to intermixing” within the meaning of the invention means that no barrier to intermixing is provided which would substantially prevent the intermixing of two fluids. This does not apply to individual ions.

The method according to the invention relates in particular to water processing or treatment. The method is preferably used for producing a cleaning fluid. The fluid that leaves the treatment device after a treatment or activation still to be described below can be used as a cleaning fluid.

Such a cleaning fluid can be provided e.g. for the cleaning or disinfection of surfaces or of the human body (e.g. before or during operations or for disinfecting the body), or to clean or disinfect machines (such as e.g. washing or cleaning machines) or in the agricultural industry sector (e.g. for cleaning or disinfecting fruit or vegetables or equipment used for the processing thereof).

Alternatively, the method according to the invention can be used for water purification, e.g. of waste water, or even for producing hydrogen (e.g. as a fuel for vehicles). In principle, the method according to the invention may also affect energy production.

According to the invention, an aqueous solution is used, which in particular is understood within the meaning of the present invention to be a mixture in which water is employed as a solvent. The water can preferably be decalcified water, i.e. substantially soft water (e.g. with a German hardness degree of 0).

The aqueous solution furthermore comprises a dissolved substance, in particular in order to achieve a certain ionization. Preferably, the aqueous solution comprises dissolved salt or sodium chloride. According to the invention, therefore it can be an aqueous salt solution.

According to the invention, in preparation of the method (or as part of the method), a salt solution may be added to, and in particular injected into, decalcified water. For example, the salt solution can have a salt content of 20 to 25%. The aqueous solution, which is then further treated or activated or introduced into the treatment device, only has a salt content of less than 0.35%, preferably about 0.2%, according to the invention, which is significantly less than in the prior art, so that the present invention in particular allows for a more cost-effective production of a cleaning fluid.

However, the aqueous solution can also be waste water or contaminated water or similar.

The aqueous solution can be introduced into an electrochemical treatment device, and in particular conveyed through said electrochemical treatment device. According to the invention, such a treatment device has an electrode pair to which typically a direct current is applied. When current is applied, said aqueous solution can then stream or flow through said electrode pair. In this process, the aqueous solution is typically activated, wherein in particular ions of the solution are attracted to the electrodes (according to their charge).

One of the electrodes is typically configured as an anode and the other as a cathode.

Preferably, the two electrodes can be arranged coaxially; in an alternative embodiment, on the other hand, non-coaxially and parallel.

In particular, it can be provided that one of the two electrodes provides a circumferential surface of the treatment device or of a treatment chamber (preferably the cathode).

The treatment device generally comprises a treatment chamber, in particular precisely one treatment chamber. The treatment chamber is typically provided with (precisely one) inlet for the aqueous solution and, in particular at its other end, with (precisely one) outlet for the activated aqueous solution or fluid.

The activated solution leaving the treatment device through said outlet can then be used directly as a cleaning fluid without the need for further mixing or a further additive. For this purpose, the cleaning fluid can e.g. be passed into a storage or reservoir tank or vessel.

According to a particularly advantageous embodiment of the invention, the aqueous solution is introduced into a treatment chamber in the treatment device and/or discharged therefrom through one of the electrodes. The electrode can have at least one channel for this purpose, and advantageously two. The electrode can be the anode, for example. This electrode is typically arranged centrally in the treatment device.

The electrode can have an entry and/or an exit for this purpose. Entry and exit are typically arranged on opposite sides of the electrode.

Preferably, a chamber access is assigned to the entry and/or exit of the electrode. In this way, the aqueous solution can, for example, enter an entry of the electrode and leave said electrode (enter the chamber) in the region of a chamber access. Furthermore, it can be provided that, particularly after a treatment or electrochemical activation, the aqueous solution reenters the electrode through another chamber access (or chamber exit) of the electrode, and leaves said electrode (and the entire treatment device) at an exit.

The treatment chamber in this case typically has connections to both electrodes. For example, the electrode according to claim 2 can be surrounded coaxially by the treatment chamber.

In an alternative embodiment, both the electrode according to claim 2 and the other electrode of the pair can be arranged jointly in the treatment chamber. What is crucial according to the invention is that a region that is open to intermixing is configured between the two electrodes, i.e. in particular no membrane or diaphragm is arranged there.

Particularly advantageously, it is provided that at least one end region of said electrode has a hollow configuration. This allows the electrode to provide a channel for the access or exit of the aqueous solution.

In a particularly advantageous exemplary embodiment, the electrode in this case has a solid configuration in a central region. In other words, the channel does not extend through the whole of the electrode. In particular, a first end region of the electrode can comprise a channel (in particular for access to the treatment chamber) and the opposite end region can comprise a further channel (in particular for exit from the treatment chamber).

The electrode (in particular the anode) according to the invention can, for example, be configured as a rod electrode and/or may consist of titanium.

Advantageously, the central electrode has a mixed-oxide-coating.

According to a further particularly advantageous embodiment of the invention, the treatment device comprises a bypass. This bypass can in particular be assigned to or connected to a treatment chamber of the treatment device.

Such a bypass serves in particular to counteract a build-up of gas or air in the treatment chamber, respectively to dissipate it and to prevent that by this non-activated solution passes through the chamber and reaches the exit.

So that gas or air is not discharged from the treatment device with non-activated aqueous solution in too great a proportion, the bypass can be used to return the gas or air to the beginning of the treatment chamber. The fluid or aqueous solution entrained by the gas or air can then undergo a complete activation process (again).

Particularly in arrangements in which the treatment device is oriented vertically, the gas or air rises rapidly upwards towards the chamber exit, and can unintentionally carry aqueous solution with it in the process. The return of the aqueous solution (with the gas or air), in this case, offers an improved quality of the finished, activated aqueous solution or the cleaning fluid prepared therefrom.

So that aqueous solution that has not yet been fully treated or activated cannot utilize the bypass to pass from the chamber entry to the chamber exit without activation, the bypass preferably has a check valve which substantially blocks a passage direction from the chamber entry towards the chamber exit. In this way it can be ensured that the aqueous solution does not simply take the diversion via the bypass, which would naturally reduce the quality of the cleaning fluid.

For this purpose, the bypass comprises an entry in the region of the chamber exit and an exit in the region of the chamber entry.

According to a further advantageous embodiment of the invention, the aqueous solution has a salt content of less than 0.35%, more preferably of less than 0.3%, more preferably of less than 0.2%, preferably about 0.2%. In contrast to the salt contents of the aqueous solutions of the prior art, the present method uses a less salty solution, which naturally means lower production costs for the cleaning fluid since the water content in the aqueous solution is higher.

The solvent in the aqueous solution can be, in particular, decalcified or soft water. To prepare the aqueous solution, this can be mixed with a concentrated, salt-containing solution. Together with the treatment device, an appropriate injection apparatus can belong to a system. This system can also comprise a delivery line or a reservoir of the (decalcified) water or optionally even a decalcifying filter or the like.

Advantageously, it is provided that the activated aqueous solution has a pH value of between 7 and 10, in particular between 8 and 9, after leaving the treatment device or treatment chamber. This target is achieved in particular by using a treatment device according to the invention which is configured such that it is open to mixing in the region of the electrode pair.

In contrast to the prior art, therefore, the activated aqueous solution itself can already be used as a cleaning fluid, in particular since it has an appropriate pH value.

Advantageously, the activated aqueous solution or cleaning fluid has a redox potential of between 650 and 800 mV. Such a fluid has proved to be an ideal cleaning agent.

According to a particularly advantageous embodiment of the invention, precisely one fluid inlet is assigned to the electrode pair. In other words, the chamber in which the electrode pair is located or which is formed by the electrode pair can comprise precisely one fluid inlet for the aqueous solution. Alternatively or in addition, this chamber can also comprise precisely one fluid outlet. This should be seen in contrast to the prior art, in which two fluid inlets and two fluid outlets are assigned to each electrode pair, in particular since two differently activated cleaning fluids are also formed or can pass out of the treatment device.

It can therefore be provided that the treatment device in particular comprises precisely one fluid inlet and/or one fluid outlet.

According to the most preferred embodiment of the invention, the electrodes of the electrode pair jointly form a chamber of the treatment device. For this purpose, one of the electrodes can r, for example, surround the other, in particular coaxially. One of the electrodes, preferably the central electrode, can be a rod electrode and the other can have a sheath-like, in particular a cylindrical sheath-like, shape and preferably provide a circumferential surface of the treatment device.

According to the invention, the two electrodes are connected to a direct current circuit. The aqueous solution fed between them in this case can also be referred to as an ion conductor or electrolyte.

According to an embodiment, the electrodes of the electrode pair are arranged jointly in a chamber of the treatment device. They can be arranged e.g. in parallel. In this case they do not form the chamber between them but are arranged in the chamber. However, they can also, for example, each form half of the wall area of the chamber or the like.

According to a further aspect of the invention, the object consists in providing an optimized cleaning fluid. The invention achieves this object with the features of claim 9. In this respect, a cleaning fluid is provided which is produced according to one of the methods described. Preferably, the activated aqueous solution that leaves the treatment device can be used directly as a cleaning fluid. In this case it is preferably not provided with further additives and/or is not treated further or mixed with another solution or another fluid.

All the above-mentioned advantages and/or special features (including, for example, those relating to the pH value mentioned) are intended to apply to the cleaning fluid.

Finally, a last aspect of the invention relates to an electrochemical treatment device. The object is considered to be creating a simpler electrochemical treatment device than is known from the prior art.

The invention achieves this object with the features of claim 10. It should be noted at this point that all the advantages or special features described in relation to the method according to the invention or the cleaning fluid according to the invention should also apply to the electrochemical treatment device and/or are to be deemed to be disclosed in association therewith. Related repetitions are omitted purely for reasons of the legibility of the present application.

Further advantages of the invention may result from the claims, which may not have been cited, and from the following description of the figures. These show:

FIG. 1 a and

FIG. 1 b respectively show a method and a device according to the prior art, which was described above, in two different views,

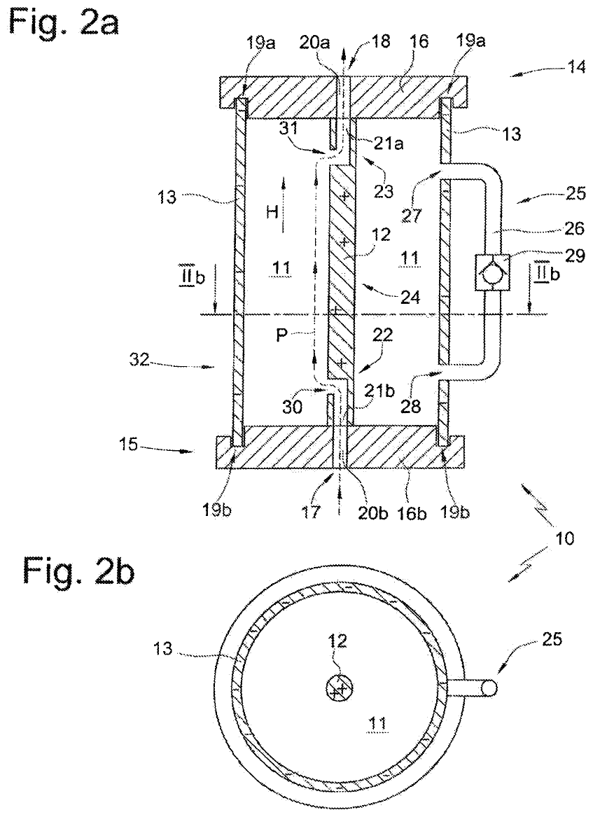

FIG. 2a shows a treatment device according to the invention for implementing a method according to the invention in a highly schematic sectional side view,

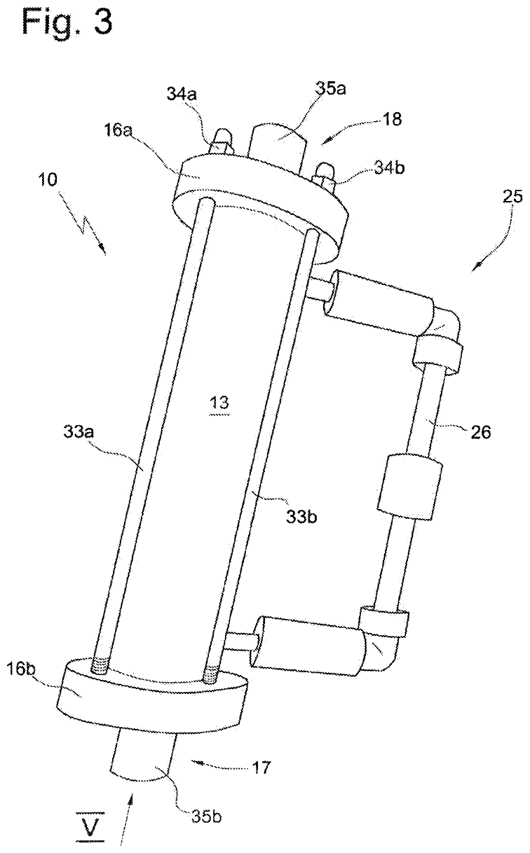

FIG. 2b shows the device according to FIG. 2a in a schematic sectional view, approximately along the line IIb-IIb in FIG. 2a, FIG. 3 shows a perspective, isometric external view of the treatment device according to FIG. 2, with the additional illustration of mounting struts,

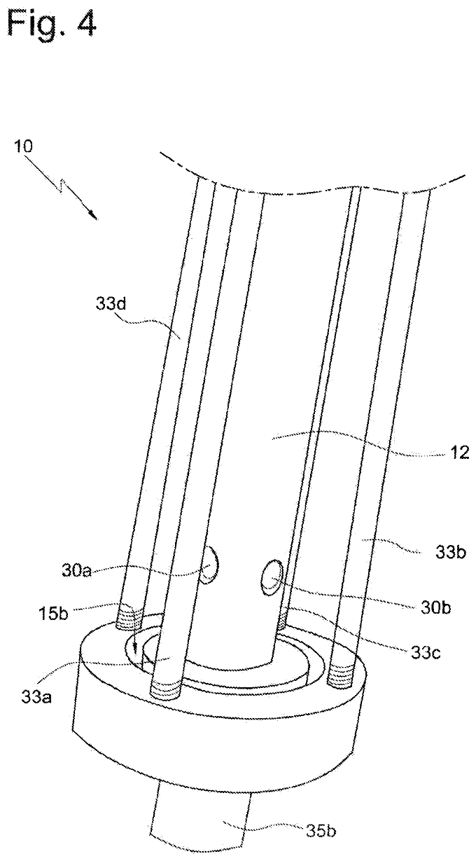

FIG. 4 shows, in a view that is somewhat tilted relative to FIG. 3, a section of the device according to FIG. 3 with the cylindrical sheath unmounted, in particular to illustrate the chamber entries in the central electrode,

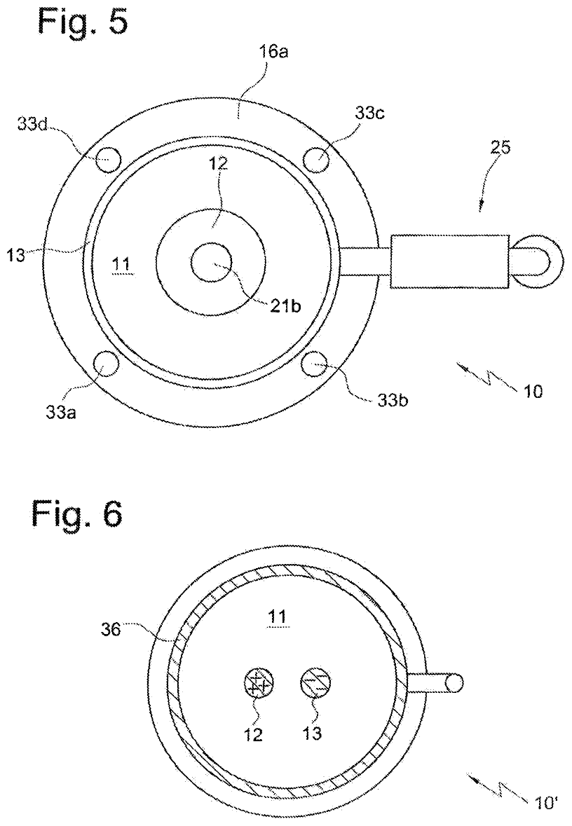

FIG. 5 shows a highly schematic bottom view of the device according to the invention according to FIGS. 2 to 4, approximately along the arrow V in FIG. 3, but with the bottom mounting plate removed, in particular to give a clearer view of the fluid entry/channel in the central electrode,

FIG. 6 shows, in a view approximately according to FIG. 2b, a second exemplary embodiment of a device according to the invention for carrying out a method according to the invention, but in which the electrodes are arranged not coaxially but such that they are offset parallel to each other, and

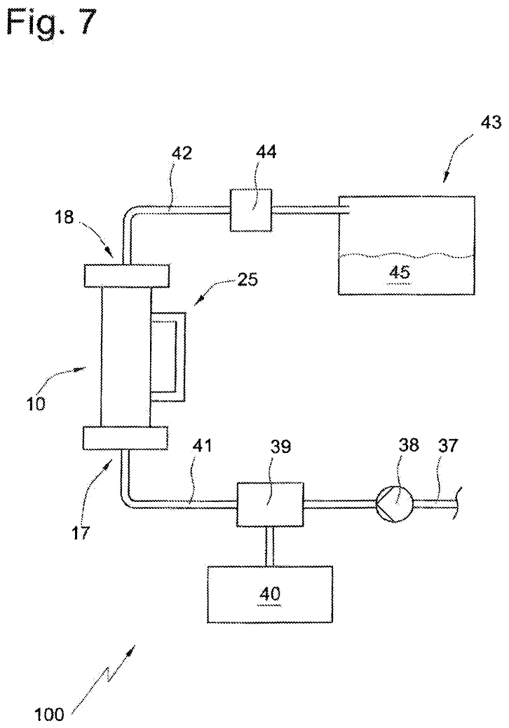

FIG. 7 shows a highly schematic diagram of a system according to the invention for implementing the method according to the invention, comprising a treatment device according to one of FIGS. 2 to 6.

The following description of the figures and the claims should be preceded by mentioning that identical or comparable parts are provided with identical reference signs where appropriate, with the addition of lower case letters or apostrophes in some cases.

Firstly, a treatment device 10 according to the invention for use in a method according to the invention will be described with reference to FIG. 2a:

Thus, the treatment device 10 in principle forms a treatment chamber 11 in its interior which, in the exemplary embodiment illustrated, as in particular can also be seen in FIG. 2b, is configured such that it is substantially circular in cross-section.

The treatment chamber 11 is in particular configured such that it is open to intermixing, i.e. compared to the exemplary embodiment of the prior art according to FIG. 1 neither a membrane nor a diaphragm nor any other intermixing-barrier is arranged in its interior.

A first electrode 12 in the form of a rod anode is arranged centrally in the treatment chamber 11. Coaxially to the anode 12, the second electrode 13 is arranged, which is configured in the manner of a cylindrical sheath and at the same time provides the outer sheath of the device 10.

For the treatment or activation of an aqueous solution (not illustrated), the two electrodes 12 and 13 are connected to direct current, so that they are parts of an electrical circuit. The connection of each of the two electrodes 12 and 13 can take place in a conventional manner but is deliberately not illustrated in the figures for reasons of clarity.

The device 10 according to the invention, which is of substantially cylindrical configuration in the exemplary embodiment, comprises in each of its top region 14 and its bottom region 15 a mounting plate 16, which is in particular disc-like and preferably circular. The two mounting plates 16a and 16b are preferably configured identically.

Firstly, the mounting plates 16a and 16b each comprise a circumferential receiving groove 19, which is circular in the exemplary embodiment, for receiving the cylindrically designed outer electrode 13 (in at least one of the mounting plates 16 an electrical connection, not illustrated, for the electrodes will typically be provided).

In addition, the mounting plates 16 each comprise a central, channel-like through-passage 20, the outer side of which is assigned to the discharge 18, respectively the feed 17 of the device 10.

These through-passages 20a and 20b are aligned with the electrode 12, in particular each with a channel 21 in an end of the electrode 12.

For this purpose, the electrode 12 is substantially rod-shaped and is hollow in both its first end region 22 and its second end region 23, specifically to form the said channels 21a and 21b. The channels 21a and 21b therefore extend substantially axially in the end regions 22 and 23 of the electrode 12.

In its central region 24, on the other hand, the electrode 12 is not hollow but is solidly configured.

Finally, FIGS. 2a and 2b also show a so-called bypass 25, which is a device that in particular comprises a fluid pipe 26, which is fixedly arranged on the outer side of the cylinder or the electrode 13.

The pipe 26 here forms a bypass entry 27 and a bypass exit 28 in the region of the treatment chamber 11.

Furthermore, the bypass 25 comprises a check valve 29, which prevents the through-passage of fluid through the bypass 25 in the direction from the exit 28 towards the entry 27, while through-flow from the direction of the entry 27 towards the exit 28 is permitted.

The method according to the invention will now be described with reference to FIG. 2a as follows:

According to the invention, an aqueous solution, in particular an aqueous salt solution or sodium chloride solution, which has a salt content of less than 0.35%, advantageously 0.2%, is fed to the device 10 via the feed 17.

This is therefore an ionized fluid, which is to be activated in the electrochemical device 10. For this purpose, a direct current is applied to the electrodes 12 and 13 during the method according to the invention, so that the electrodes 12 and 13 are part of an electrical circuit in which the aqueous solution to be activated provides the conductive medium or electrolyte.

Further details of the production of the aqueous solution will be given below in connection with the description of FIG. 7. In any case, the electrical solution enters the device 10 substantially vertically in the region of the feed 17, flows through the through-passage 20b and passes into the channel 21b of the anode 12. This channel 21b forms multiple chamber inlets in the electrode 12, only one of which can be seen in FIG. 12a, however.

In this way, the aqueous solution to be activated arrives in the chamber 11.

The path of the aqueous solution to be activated through the device 10 is indicated in FIG. 2a with a broken arrow line P. As can be seen from FIG. 2a, the solution here flows through the chamber 11 along a main flow direction H and is thus exposed to the electrical field between the anode 12 and the cathode 13.

In this process, the ions in the aqueous solution can be attracted in a known manner to the anode or cathode, according to their charge, and collect there. This process is known as activation of the aqueous solution, which as a result acquires properties that differ significantly from a conventional salt solution and ultimately enable the activated aqueous solution to be used later as a cleaning fluid.

The distinctiveness of the invention therefore consists in the fact that only one aqueous solution is involved, which can flow through a (common) chamber 11 between the electrodes 12 and 13, wherein this chamber 11 is not divided into anode and cathode chambers as in the prior art. It is therefore configured such that it is open to intermixing, so that no separation into two different fluids is performed as is the case in the prior art.

Once the aqueous solution has substantially flowed through the chamber 11, it can enter the channel 21a in the second end region 23 of the anode 12 in the region of a chamber outlet 31, flow through the through-passage 20a in the top mounting plate 16a and leave the device 10 in this way (through the discharge 18). The fluid exiting at the discharge 18 can now be used directly as a cleaning fluid and can be drained off or collected in a manner to be described below (with reference to FIG. 7).

With regard to the method according to FIG. 2a, it should finally be noted that it is not entirely out of the question for gas or air inclusions to pass into the chamber 11. These generally rise upwards, respectively in the main flow direction H in the chamber 11 (it should be noted here with regard to the exemplary embodiment that the device 10 is arranged substantially vertically according to the illustration of the figure in the plane of the paper). These gas or air inclusions can entrain some of the aqueous solution, thus preventing this entrained aqueous solution from being sufficiently activated.

To counteract this effect, the device 10 comprises the above-mentioned bypass 25. In the top region of the device 10, the bypass entry 27 is accordingly provided, through which in particular said air or gas inclusions together with the entrained fluid or solution can enter the bypass. Via the pipe 26, this entrained solution and/or also the gas or air is fed back into the bottom region 32 or entry region 32 of the device 10 (against the main flow direction H), so that the initially entrained fluid can pass through the chamber 11 again, this time being sufficiently activated.

So that the fluid or solution to be activated does not pass directly into the pipe 26 of the bypass 25 (and thus out of the area of influence of the electrical field) after entering the chamber 11 via the chamber inlet 30, the bypass 25 comprises said check valve 29. In other words, the substantially non-activated solution, which “erroneously” enters the bypass exit 28, cannot simply flow through the bypass 25 and exit at the bypass entry 27 since this is precisely what that check valve prevents.

In summary, the bypass pipe 25 increases the quality of the cleaning fluid that is obtained, but it should finally be noted that although a cleaning fluid is made in the exemplary embodiment according to the figures, the identical device could easily also be utilized in other ways, e.g. for cleaning waste water or similar.

FIG. 3, then, again shows the treatment device 10 according to the invention in a perspective, isometric external view with the additional illustration of mounting struts 33, which were omitted in FIG. 2 in particular for reasons of clarity.

Thus, between the two mounting plates 16, (e.g. four) mounting struts 33 can be provided (only two of which can be seen in FIG. 3 for reasons of perspective), which ensure the stability of the device 10. These mounting struts 33 can form appropriate threads in their end regions and engage through the mounting plates 16a and 16b for mounting purposes. When exiting the mounting plates 16, the ends of the mounting struts 33 can be secured with retaining means, such as lock nuts 34, at both ends (with regard to the bottom end, this is not illustrated in FIG. 3 for reasons of perspective).

At this point it should be noted that in FIG. 2a, purely for reasons of clarity, no through-openings for the mounting struts 33 are illustrated in the mounting plates 16a and 16b, since FIG. 2a is only intended to show a schematic diagram of the production method according to the invention.

Finally, FIG. 3 also shows connecting pieces 35 in the region of feed 17 and discharge 18, which can be used e.g. for connecting feed hoses or drain hoses (likewise omitted in FIG. 2a for the sake of clarity).

FIG. 4 then shows the bottom part of the device 10 according to the invention according to FIG. 3 in a perspective that is slightly tilted or raised relative to FIG. 3, in which the outer sheath 13 of the device 10, configured as an electrode, is omitted.

This illustration is intended in particular to show the chamber inlets 30 in the rod anode 12, two of which (out of e.g. four) are illustrated in FIG. 4. Via the chamber inlets 30, the solution to be activated, which is fed into the device 10 in particular via the connecting pieces 35b, initially leaves the anode 12 and enters the chamber 11 between the sheath electrode 13 (removed in FIG. 4) and the anode 12. In the top region, not illustrated in relation to FIG. 4, the anode 12 comprises identical chamber outlets, or chamber inlets, 31.

The chamber outlets 30 according to FIG. 4 branch from the above-described channel 21b in the first end region 22 of the anode 12, which a highly schematic bottom view according to FIG. 5, approximately according to arrow V in FIG. 3, is intended to show more clearly. In this view, in particular the bottom mounting plate 16b is omitted so that the bottom entry to the channel 21b becomes visible. Since the device 10 is of substantially symmetrical construction, FIG. 5 could also, in principle, be a top view of the device 10 in which the top mounting plate 16a has been removed. FIG. 6 shows a second exemplary embodiment 10′ of a device according to the invention in a view approximately according to FIG. 2b. In this exemplary embodiment the method according to the invention takes place substantially identically to the one described above, with the sole difference that the sheath region 36 of the device 10′ is not configured as an electrode here. It can consist e.g. of plastic. In this case the cathode 13 is likewise configured as a rod electrode. The anode 12 and the cathode 13 in this exemplary embodiment are therefore both arranged within the chamber 11, i.e. substantially parallel but offset.

Otherwise, the devices 10′ and 10 do not differ. The only exception here is the fluid feed and discharge, which typically takes place not centrally in the chamber but typically instead through one of the two decentrally arranged electrodes 12 or 13, but still typically in the manner described above, according to which one of the two electrodes 12 or 13 is provided in its end regions 22 and 33 with an appropriate channel. The other electrode 12 or 13 can be configured completely solid, for example. Alternatively, however, one of the two electrodes can also be arranged centrally in the chamber 11 and the other one decentrally (but parallel).

Finally, FIG. 7 shows a highly schematic diagram of a system 100 for implementing the method according to the invention, which comprises a device 10 according to the invention (or 10′—this makes no difference to the present exemplary embodiment):

Thus, the system 100 first comprises a water supply line 37, with which previously decalcified or soft water is supplied to the system according to the invention. Alternatively, the system according to the invention can also comprise a water filter for decalcifying the water.

The decalcified water 37 is conveyed towards the device 10 using a feed pump 38.

In this process, it flows through an injection apparatus 39, which injects a concentrated salt solution from a vessel 40 into the decalcified water. Whereas the concentrated solution in the vessel 40 has a salt content of 20-25%, the aqueous solution in the pipe 41 that has been produced in this way (which is therefore produced from decalcified water and injected, highly concentrated salt solution) has a salt content of less than 0.35%, preferably about 0.2%.

This solution can flow into the device 10 in the region of the feed 17, and be activated in the device 10 in the manner described. In the region of the discharge 18 it can leave the device 10 and be drained off via a drain 42, e.g. into a collecting vessel 43, in particular of a tank type.

In order that the tank 43 does not overflow, a solenoid valve 44, for example, can be provided upstream of the tank 43. A dosing apparatus for mixing two fluids as in the prior art is not necessary (anymore), however.

The activated solution 45 collected in the tank 44 can be used directly as a cleaning fluid 45 and filled into e.g. smaller canisters, bottles or similar.

This fluid 45 has a pH value of between 8 and 9 and a redox potential of between 650 and 800 mV.

1. A method, in particular for producing a cleaning fluid, comprising conveying an aqueous solution through a treatment device, in particular an electrochemical treatment device, that comprises an electrode pair through which the aqueous solution flows, in particular for the activation thereof, characterized in that the region between the electrodes of the electrode pair is configured such that it is open to intermixing, and in particular is free from a membrane or diaphragm.

2. The method according to claim 1, characterized in that the aqueous solution is fed into and/or discharged from a treatment chamber of the treatment device through one of the electrodes, in particular the anode.

3. The method according to claim 2, characterized in that the electrode has a hollow configuration in at least one end region, in particular to provide a channel, but preferably is solid in a central region.

4. The method according to claim 1, characterized in that the treatment device comprises a bypass, in particular comprising a check valve.

5. The method according to claim 1, characterized in that the aqueous solution fed into the treatment device, for which in particular decalcified water is used, has a salt content of less than 0.35%, preferably about 0.2%.

6. The method according to claim 1, characterized in that the activated aqueous solution has a pH value of between 8 and 9 and/or a redox potential of between 650 and 800 mV after exiting the treatment device.

7. The method according to claim 1, characterized in that precisely one fluid inlet and/or one fluid outlet is assigned to the electrode pair, and in particular the treatment device comprises precisely one fluid inlet and one fluid outlet.

8. The method according to claim 1, characterized in that the electrodes of the electrode pair jointly form a chamber of the treatment device, for which purpose they are preferably arranged coaxially, or in that the electrodes of the electrode pair are jointly arranged, preferably parallel, in a chamber of the treatment device.

9. A cleaning fluid, produced in a method according to claim 1, in particular characterized in that the activated aqueous solution is used directly, preferably without further additives, as a cleaning fluid.

10. An electrochemical treatment device, in particular for use in a method according to claim 1, which comprises an electrode pair through which an aqueous solution can flow, characterized in that the region between the electrodes of the electrode pair is configured such that it is open to intermixing, and is in particular free from a membrane or diaphragm.
